(19) United States
(12) Patent Application Publication
(10) Pub. No.: US 2009/0304071 A1
(43) Pub. Date: Dec. 10, 2009

(54) ADAPTIVE APPLICATION OF ENTROPY CODING METHODS

(75) Inventors: Xiaojin SHI, Fremont, CA (US); Hsi-Jung WU, San Jose, CA (US)

Correspondence Address: KENYON & KENYON LLP, 1500 K STREET NW, SUITE 700, WASHINGTON, DC, 20005-1257, US

(73) Assignee: APPLE INC., Cupertino, CA (US)

(21) Appl. No.: 12/415,461

(22) Filed: Mar. 31, 2009

Related U.S. Application Data
(60) Provisional application No. 61/059,612, filed on Jun. 6, 2008.

(51) Int. Cl. H04N 7/26

(52) U.S. Cl. 375/240.02; 375/240.26; 375/E07.126

(57) ABSTRACT

Disclosed is an exemplary video coder and method that provide a video decoder control method for analyzing data to schedule coding of the data. Input data may be encoded to a plurality of different encoding. It may be determined if a minimum number of the plurality of different encodings comply with at least one of a bitrate constraint and a computational complexity constraint. An encoding may be selected from the compliant encodings that maximizes the quality of the decoded data. Quality may be determined based on at least one predetermined metric related to the selected encoding; and the selected encoding may be delivered to an output buffer.

### PRIORITY CLAIM

The present application claims priority to provisional application 61/059,612, filed Jun. 6, 2008, the contents of which are incorporated herein in their entirety.

### BACKGROUND

Disclosed are methods of constructing bitstreams by switching between entropy coding methods as the bitstream is being encoded, thereby overcoming decoding data complexity barriers and/or bitrate considerations.

In modern video coder/decoders (codecs), the entropy coding process influences the throughput of the codec. In order to maintain playability on resource/power restricted playback devices, bitstreams are often constructed either with a low complexity, low compression entropy coding method that is easy to decode but yields more bits, or with a high complexity, high compression entropy coding method that yields less bits but is difficult to decode.

For example, the H.264 standard allows two types of entropy coding: Context-Adaptive Variable Length Coding (CAVLC) and Context-Adaptive Binary Arithmetic Coding (CABAC). Each has its advantages and disadvantages.

CABAC has better coding efficiency than CAVLC, but is much more computationally complex to encode or decode than CAVLC. CABAC provides picture data having a higher number of bits than CAVLC; however, on power or resource limited devices, CABAC bitstreams may need to be severely limited in bitrate reducing picture quality.

In contrast, CAVLC is not as efficient as CABAC but it is a computationally much less complex coding method. For scenarios in which the transmission channel and the devices involved can handle higher data rates, CAVLC can be used to code the bitstream, but at the expense of coding efficiency and reduced display quality due to the lesser number of bits.

The inventors of the present application propose several coding embodiments for improving coding efficiency and quality.

### BRIEF DESCRIPTION OF THE DRAWINGS

FIG. 1 illustrates a block diagram of a video coding system according to an embodiment of the present invention.

FIG. 2 illustrates an exemplary data source encoding according to an embodiment of the present invention.

FIG. 3 illustrates an alternative block diagram of a video coding system according to an embodiment of the present invention.

FIG. 4 illustrates an exemplary flowchart of a method according to an exemplary embodiment of the present invention.

FIG. 5 illustrates yet another alternative block diagram of a video coding system according to an embodiment of the present invention.

### DETAILED DESCRIPTION

Embodiments of the present invention provide a method for encoding video data. Input data is encoded into a set of encoded data. It is determined the set of encoded data complies with a given set of constraints, which include at least one of a bitrate constraint and a computational complexity constraint. A complying encoded data set that maximizes the quality of the decoded data is selected. Quality is determined based on at least one predetermined metric related to the selected encoded data set; and the selected encoding is delivered to an output buffer. The selected encoded data set is delivered to an output buffer.

Embodiments of the present invention provide a video coder system that includes a video data source, a model storage, an encoder and an output data buffer. The model storage stores a plurality of models of various coder system components that model the performance of the different components of the coder system. The encoder, coupled to the model storage, encodes data received from the video data source with reference to the plurality of models. The encoder includes a plurality of processors.

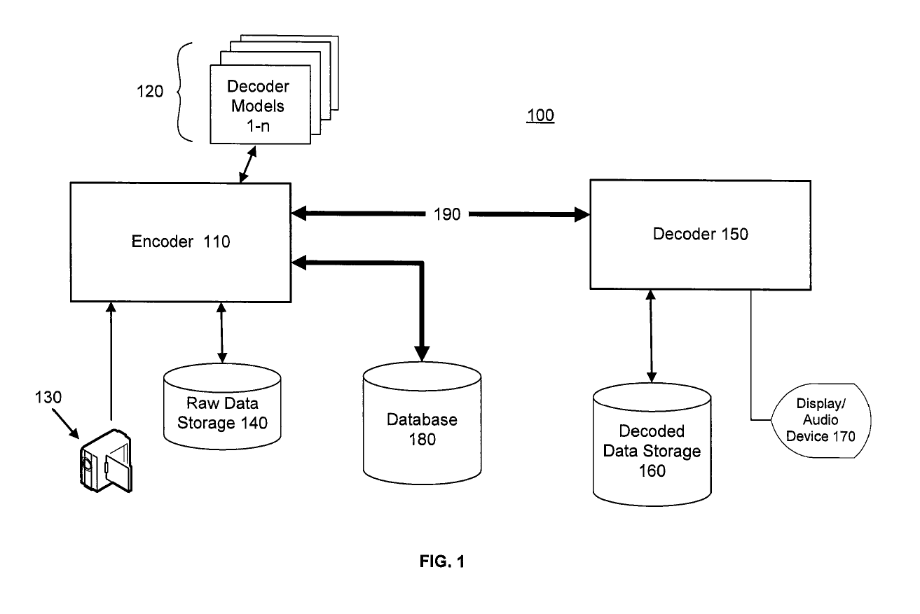

FIG. 1 is a simplified block diagram of a layered video decoder 100 according to an embodiment of the present invention.

The exemplary video system 100 comprises a video encoder 110 and a video decoder 150 connected by communication channel 190.

The video encoder 110 receives video source data from sources, such as camera 130 or data storage 140. The data storage 140 may store raw video data. The encoder 110 codes the received source data for transmission over channel 190. The coding may include entropy coding processes. Encoder 110 makes coding decisions designed to eliminate temporal and spatial redundancy from a source video sequence provided from sources of video and audio data, such as a video camera 130 or data storage 140. The encoder 110 can comprise a processor, memory and other components configured to perform the functions of an encoder.

The encoder 110 may make the coding decisions with reference to decoder models 120. Video encoder 110 analyzes video sequences of the source input data, and may decide how to encode the source video sequence by referencing at least one of the decoder models 120. Preferably, at least one of the decoder models 120 models the performance of a target decoder and possibly the transmission channel 190. The decoder models 120 can be stored in tables or other data structures. There can be a plurality (1−n) of models 120 or only one model.

The video encoder 110 can make coding decisions on a picture-by-picture, frame-by-frame, slice-by-slice, macroblock-by-macroblock basis to comply with any standard, and even a pixel-by-pixel basis, if such an implementation would be desirable. The video encoder 110 can make coding decisions on a bitstream element by bitstream element basis (e.g. motion vectors in a particular macroblock might be encoded using a different entropy coding method than the prediction residuals of the same macroblock).

According to the H.264 standard, the entropy coding method used for the bitstreams can be provided in the picture parameter header of the bitstream. The picture parameters indicate the type of decoding to be performed on encoded data on a picture-by-picture basis.

The decoder models 120 can model complexity limitations and decoding strengths, and other performance parameters of the target decoder 150 and transmission characteristics of the transmission channel 190. Based on the modeled performance parameters of the target decoder 150, the transmission channel 190, and a desired delivery bitrate, a combination of entropy coding methods (e.g. CABAC and CAVLC in H.264) can be planned to insure maximum efficiency of the decoding process to provide data for a high quality display at substantially the desired delivery bitrate.

Encoded data can be stored in database 180 for future delivery to a target decoder 150 depending upon whether the encoded data has been encoded according to a model 120 of the target decoder 150. Of course, multiple encoded copies of the source data, each encoded according to one of a plurality of models 120, can be stored in database 180 for future delivery.

Video decoder 150 receives encoded data from the channel 190, a replica of the source video sequence from the coded video data is decoded, and the replica sequence is displayed on display/audio device 170 or saved in storage 160.

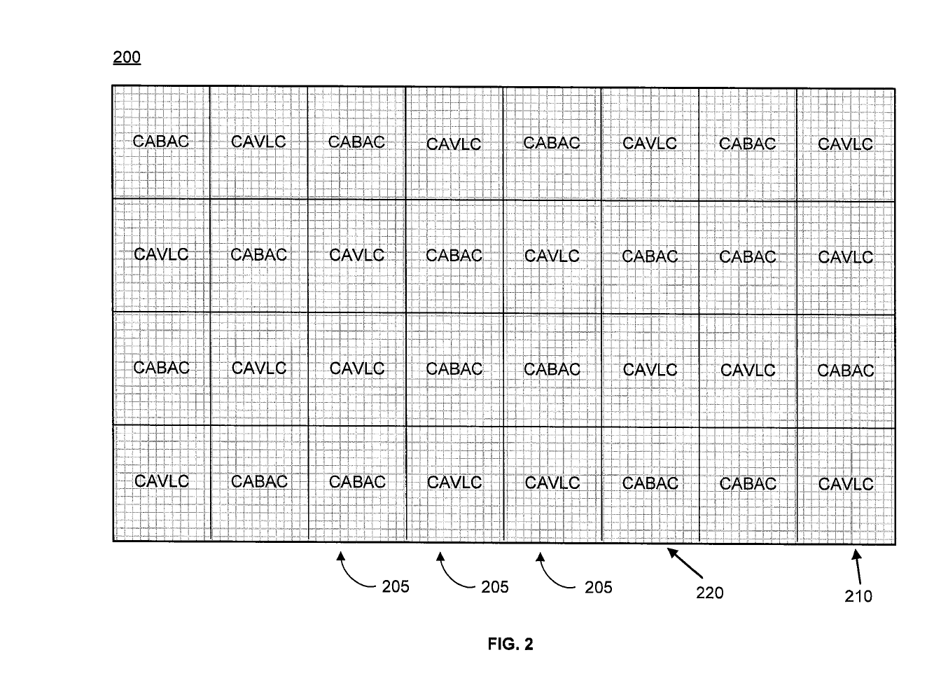

The video source data received from sources, such as camera 130 or data storage 140, is initially segmented using known techniques into blocks of data for encoding. The blocks of data can be of various sizes, such as uniform blocks of 4×4 data blocks, 8×8 data blocks, 16×16 data blocks, non uniform blocks, e.g. 14×17 data blocks, or any group of blocks. The blocks can represent pictures, frames, metablocks, individual pixels or sub-pixels. FIG. 2 illustrates an exemplary data source encoding according to an embodiment of the present invention. The encoded source data 200 is shown divided into 32 blocks of encoded data with squares within each of the 32 blocks representing an even greater level of video data detail. The 32 blocks may represent a picture, a slice, a macroblock or a pixel, and the smaller squares can represent a portion of a picture, a portion of slice, a portion of a macroblock, or a sub-pixel. One of ordinary skill in the art would understand that 32 blocks were chosen for purposes of illustration, and that fewer or more blocks could have been selected. Additionally, it can be appreciated that as encoding of the input data progresses, the granularity of the input can switch between frames, metablocks or pixels and vice versa.

Each of the large blocks 205 in FIG. 2 is shown with the type of entropy coding to be performed on the video data, which may be represented by the smaller squares within each square. The entropy coding CABAC 220 and CAVLC 210 are shown because these are specified by the H.264 standard, but, of course, other types of entropy coding can be used.

If the above entropy coding is implemented the average coding complexity of the data output from the encoder will be, say, 50 percent (50% CABAC and 50% CAVLC). This average can be adjusted based on the performance capabilities of a target decoder. Performance capabilities that can be considered include the loading of decoder processor, power consumption/level restrictions and the like.

The entropy coding for each picture may be predetermined based on, referring back to FIG. 1, the selected model 120 of the target decoder 150 or channel 190, and switching by the encoder 110 between CABAC and CAVLC and vice versa to encode the data to meet the delivery data bitrate, or maximum decoding efficiency, or maximum number of bits of data that can be decoded to provide the highest maximum display quality.

The encoded source data 200 generated by encoder 110 may include an indicator of the type of entropy encoding used for a particular data set. This indicator may be included in a picture parameter header that is sent prior to all of the data being transmitted to the decoder. The encoding may alternate between the entropy coding methods on a frame-by-frame (or slice-by-slice, macroblock-by-macroblock, or pixel-by-pixel basis), such as for example, all even frames are encoded with CABAC and all odd frames with CAVLC, as the encoding progresses.

Although discussed at a picture level, the coding can be performed at an even lower granularity, such as slice, macroblock, or, even, at a pixel or sub-pixel level.

The encoder 110 can construct an encoded data bitstream that includes the type of encoding method used to encode the video source data. Entropy coding methods that vary from macroblock-to-macroblock (or slice-to-slice, frame-to-frame, or pixel-to-pixel basis) can be signaled to the target decoder 150 with a number of bits (which are themselves entropy coded) for each macroblock or by encoding the type of encoding method in combination with the macroblock type.

Entropy coding methods can be signaled for any set of pixels by designated, for example, a number of bits per set of pixels. The bits used for signaling may also be entropy coded to reduce the bitrate overhead.

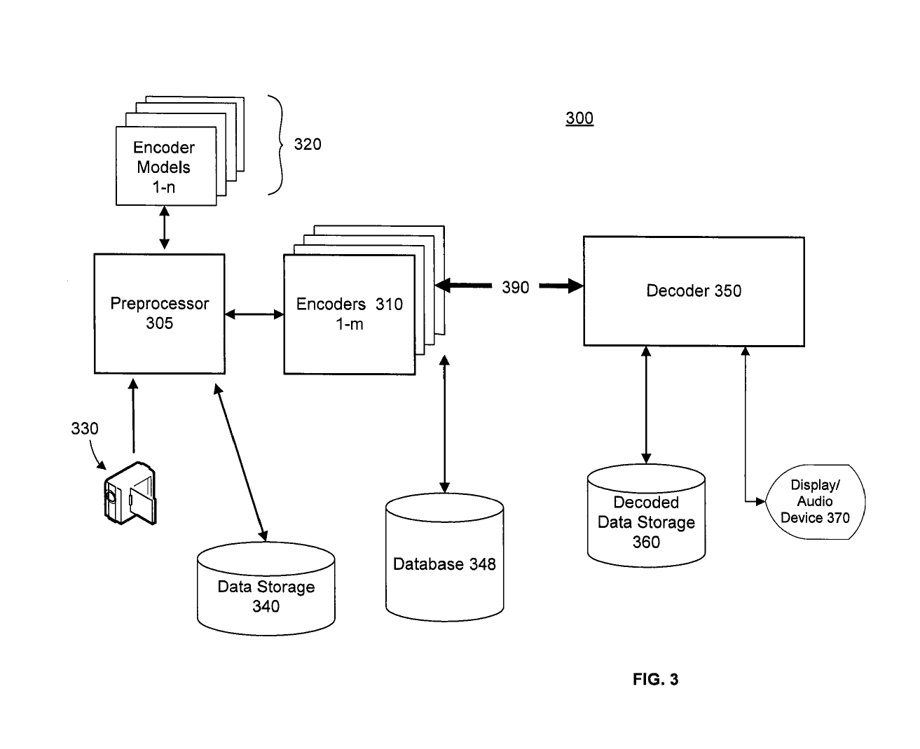

In another embodiment shown in FIG. 3, the exemplary system 300 can comprise a preprocessor 305, 1−n encoder models 320, 1−m encoders 310, video sources such as camera 330 and data storage 340, encoded data database 348, decoder 350, decoded data storage 360 and display device 370.

By referencing the models 320 of available encoders, the pre-processor 305 can select an encoder 310 that can provide encoded data at a predetermined bitrate and/or coding complexity based on the capabilities of the encoder and the characteristics of the transmission channel 390. The pre-processor 305, in real-time, may reference the models 320, encode a subset of the source data from video sources, make a determination of which of the 1−m encoders 310 can perform the encoding to meet the predetermined bitrate and/or coding complexity of the target decoder 350 and/or channel 390, and forward the data to the selected encoder(s) from the 1−m encoders 310.

By analyzing the coding results from a variety of 1−m encoders 310 that meet the bitrate and coding complexity requirements, the pre-processor 305 can select a most efficient or most practical or most universally accepted encoder or set of encoders can be selected as a final encoder or set of encoders of the source data.

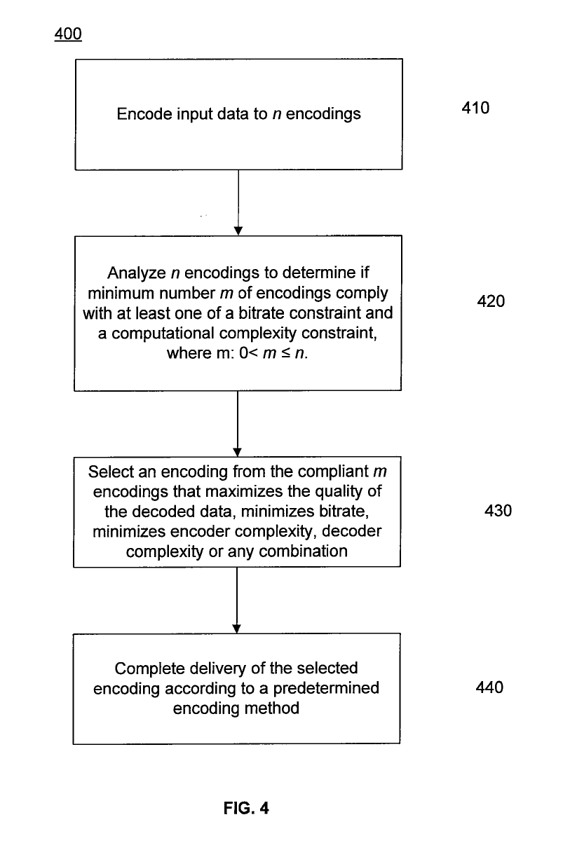

FIG. 4 illustrates an exemplary flowchart of a process according to an exemplary embodiment of the present invention. The process 400 may be performed by an exemplary system such as those shown in FIGS. 1 and 3 according to processor executable instructions. The process 400 can be performed by 110 with reference to decoder models 120 or by pre-processor 305 with reference to encoder models 420. Of course, the systems illustrated in FIGS. 1 and 3 may be modified, in which case, process 400 may also be implemented on the modified systems.

After receiving video source data as input data, the input data is encoded into a number of encodings at step 410, where n can be all of, or a subset, of available encoders. The input data may be a given set of pixels that are encoded by any number n encoders of CABAC and CAVLC encodings over a wide range of bitrates. Additionally, the encoded input data can be a subset of a portion of the input data.

At step 420, the encoded data in each of the n encodings is analyzed to determine if a minimum number m of encodings comply with at least one of a bitrate constraint and a computational constraint, where m: 0<m≦n, where m and n can be equal to or greater than 1. The minimum number m of encodings can be equal to or less than the number n of encodings. Preferably, a number m of the encodings complies with both the bitrate constraint and the computational complexity constraint. Alternatively, when subsets of the input data are encoded, the subset of a portion of the input data can be encoded according the selected compliant encoding method.

The bitrate constraint might be specified as an average bitrate target over a number of sets of encodings, a statistical or numerical bitrate analysis result, or other metric related to delivery bitrate. The computational complexity constraint might be specified as an average complexity target over a number of sets of encodings a statistical or numerical computational complexity analysis result, or other metric related to decoding computational complexity. The computational complexity constraint can also be based on the output channel, the capabilities of the encoder, and the capabilities of the target decoder(s). The computational complexity constraint can be determined based on analysis including averaging or some other statistical analysis of the bitstream.

The analysis of the encodings performed in step 420 may be a continuous analysis of the entire bitstream or an analysis of a portion, e.g., several milliseconds, of the output bitstream, or another suitable analysis technique. The analysis determines whether the output bitstream bitrate is greater than a constrained, or reference, target bitrate. The reference bitrate can be based on an output channel, the capabilities of the encoder, and the capabilities of the target decoder(s). The analysis can include averaging or some other statistical analysis of the bitstream.

At step 430, an encoding can be selected from the compliant m encodings found during the analysis performed at step 420 that maximizes the quality of the decoded data, minimizes bitrate, minimizes encoder complexity, provides all of the preceding or any combination of the preceding. Quality can be objectively defined by the encoding of the source data that delivers, or is related to, the maximum bitrate without exceeding the bitrate constraint and is the most computationally complex without exceeding the computational complexity constraint, or only the maximum bitrate, or only the most computationally complex, or some other objective measurement based on target decoder or channel.

Upon selection of an encoder, delivery of the encoded data is completed to a target decoder, according to the chosen encoding method at step 440. The encoded data may alternatively be delivered to a device comprising the target decoder, or data storage for future deliver or decoding of the encoded data. Of course, additional steps can be added to further refine the process, or steps removed to broaden the process.

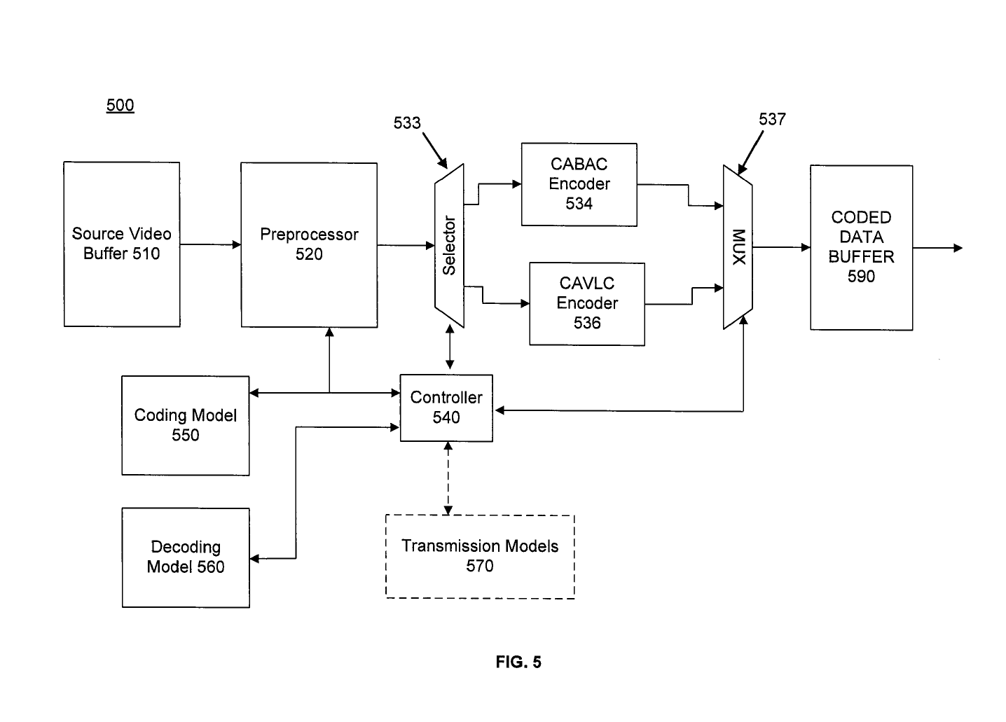

FIG. 5 illustrates an exemplary system according to an exemplary embodiment of the present invention. The exemplary system 500 comprises a source video buffer 510, a pre-processor 520, a selector 533, a CABAC encoder 534, a CAVLC encoder 536, a multiplexer (MUX) 537, a controller 540, a coding model 550, a decoding model 560, a coded data buffer 590 and optional transmission models 570.

The source video buffer 510 stores video data that is to be encoded, and similar to the systems illustrated in FIGS. 1 and 3 may receive the source video data from a camera or data storage that are not shown.

The pre-processor 520 receives source video data stored in source video buffer 510, and performs functions similar to those described above with respect to pre-processor 305 of FIG. 3 as well as other coding functions including quantization. The pre-processor 520 may access coding models 550, and use the models to make coding decisions.

The controller 540 controls the entropy coding selector 533 based on signals received from the preprocessor 510, the coding models 550, decoding models 560, and/or optional transmission models 570 as well as the coded data bitstream. The controller 540 can also make determinations, such as determining an entropy coding method, a constrained, or reference, target bitrate (i.e., output bitstream data rate), a reference coding complexity, a target decoder, decoded pixel quality, and other functions that affect encoding. The controller 540 can adjust the encoding in real time by using the coded data bitstream from MUX 537 to determine the computational complexity of the coded data bitstream.

Alternatively, the functions performed by controller 540 can be performed by or shared with the preprocessor 520 or another device, such as an external controller that is not shown. The external controller can force a particular choice of encoding. For example, the external controller can pre-set the encoding choices for an entire bitstream based on a previous encoding of the bitstream, based on feedback from the decoder, based on user preferences, or based on some other criteria.

A coding model can be selected from the coding models 550. The coding model may model the performance of the encoders, such as CABAC encoder 534 or CAVLC encoder 536, and a decoding model can be selected from the coding decoding models 560.

The controller 540 or preprocessor 520 may make encodings as it makes coding determinations. Either the controller 540 or preprocessor 520 can also determine the output bitstream data rate based on the selected entropy encoding or by direct measurement.

The selector 533 can forward the data from the preprocessor 520 to the selected entropy encoder, either CABAC encoder 534 or CAVLC encoder 536, based on the selected entropy coding method. If the selection of either the CABAC encoder 534 or the CAVLC encoder 536 is done prior to any encoding, the selector 533 may also outputs signals indicating the selected entropy coding method and data related to the data rate. The choice of an entropy coder may also affect the choice of other encoding tools/parameters, e.g. if entropy coder A is selected, it might use a different block partitioning of a macroblock than if entropy coder B were selected. The complexity or quality of the macroblock may be determined by a variety of differing conditions or situations, not just the selected entropy coder.

The multiplexer (MUX) 537 converts the encoded data into a unitary output bitstream. The output data bitstream or a portion of the output data bitstream from the MUX 537 can be forwarded to the controller 540 or the preprocessor 520 for analysis to determine if the output bitstream is within the reference data rate and the reference coding complexity based on the coding model, the decoding model or both. The controller 540 can make adjustments to selector 533 according to the results of the analysis and/or from signals from the preprocessor 520. The controller 540 can also send and receive status and control signals to and from the MUX 537. The output data from the MUX 537 can be stored in an output buffer 590.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A method for encoding data, comprising:
encoding input data into a set of encoded data;
determining if the encoded data set complies with a given set of constraints, which include at least one of a bitrate constraint and a computational complexity constraint;
selecting a complying encoded data set that maximizes the quality of the decoded data, wherein quality is determined based on at least one predetermined metric related to the selected encoded data set; and
delivering the selected encoded data set to an output buffer.

2. The method of claim 1, wherein the at least one predetermined metric is from among a maximum bitrate, a prescribed level of encoder computationally complexity and a prescribed level of decoder computationally complexity.

3. The method of claim 1, wherein the encoding comprises:
accessing models that model coding system performance.

4. The method of claim 3, wherein the encoding further comprises:
accessing decoder models that model performance of a target decoder and a transmission channel.

5. The method of claim 3, wherein the encoding further comprises:
accessing encoder models that model the performance of a target encoder.

6. The method of claim 2, wherein the encoding further comprises:
accessing transmission models that model performance of a transmission channel.

7. The method of claim 1, wherein the delivering comprises:
providing the encoded data set to an output buffer; and
delivering the encoded data set from the output buffer to at least one of a storage device and a device comprising the target decoder.

8. The method of claim 1, wherein the encoded data set is a subset of a portion of the input data; and the method further comprises:
after selecting a compliant encoding, encoding the portion of the input data from which the subset is taken in the same manner as the selected encoding.

9. A video coder system, comprising:
a video data source;
model storage for storing a plurality of models of various coder system components that model the performance of the different components of the coder system;
an encoder, coupled to the model storage, for encoding data received from the video data source with reference to the plurality of models, the encoder including a plurality of processors; and
output data buffer for storing encoded data.

10. The system of claim 9, wherein the encoder is configured to:
analyze a subset of a portion of the data received from the video data source with reference to the models stored in the model storage;
based on the results of the analysis, selecting which of the plurality of processors will encode the portion of the data; and
encoding the portion of the data.

11. The system of claim 9, the encoder further comprising:
a selector for distributing data to be encoded to at least on of the plurality of processors that performs the encoding, wherein the distributing is performed based on a control signal; and
a controller for outputting a control signal to the scheduler based on an analysis of the modeled.

12. The system of claim 9, wherein the model storage comprises at least one of a coding model storage, a decoding model storage and a transmission model storage.

13. A method for encoding, comprising:
receiving source data, wherein the source data is subdivided into subsets of source data;
encoding the received source data to a plurality of different encodings by referencing a plurality of models of target decoders and transmission channels;
selecting one of different encodings to be forwarded to a target decoder based on performance parameters of the target decoder, the target decoder having been designated to receive encoded input data; and
forwarding the selected encoding to the target decoder.

14. The method of claim 13, wherein the encoding comprises:
encoding the subsets of the source data using a context-adaptive variable length coding method and a context-adaptive binary arithmetic coding method to encode each of the subsets of the source data.

15. The method of claim 14, wherein the encoding comprises:
encoding more than half of all of the subsets of source data using the context-adaptive variable length coding method.

16. The method of claim 14, wherein the encoding comprises:
encoding more than half of all of the subsets of source data using the context-adaptive binary arithmetic coding method.

17. The method of claim 14, wherein the encoding comprises:
encoding an equal number of the subsets of source data using the context-adaptive binary arithmetic coding method and the context-adaptive variable length coding method.

18. The method of claim 13, wherein the encoding of the input data can switch from macroblock-to-macroblock, slice-to-slice, frame-to-frame, or pixel-to-pixel as the encoding of the input data progresses.
